(19) United States
(12) Patent Application Publication
(10) Pub. No.: US 2002/0096586 A1
(43) Pub. Date: Jul. 25, 2002

(54) Fishing Reel

(76) Inventor: Karl-Heinz Henschel, Nurtingen (DE)

Correspondence Address: BROWDY AND NEIMARK, P.L.L.C., 624 NINTH STREET, NW, SUITE 300, WASHINGTON, DC, 20001-5303, US

(21) Appl. No.: 09/984,802

(22) Filed: Oct. 31, 2001

(30) Foreign Application Priority Data
Oct. 31, 2000 (DE) 100 53 982.3

(51) Int. Cl. A01K 89/00

(52) U.S. Cl. 242/317; 242/283; 74/545

(57) ABSTRACT

In known reels it has been attempted to attain the desired high speed, which is intended to maintain the tension of the line when a fish is swimming quickly towards the angler, by enlarging the outer diameter. This has the shortcoming that the handle is mounted on a large radius. This makes a fast cranking from the wrist impossible. When the handle is mounted on a smaller radius the force required in the struggle with a pulling fish becomes too great, which is equally disadvantageous.

The described fishing reel is to produce the effect that a high line reel-in speed is attainable with a fish swimming towards the angler and a low force is attainable in the struggle with a pulling fish.

The object is met in such a way that a handle 2 with a small radius and a second handle 3 with a large radius is assigned either to the spool 6 in reels of the direct-drive type or to the crank 1 in reels of the anti-reverse type.

The present invention relates to a fishing reel, especially for fly fishing. The system serves to increase the reel-in speed for the line without having to put up with the negative effect of an increased required crank-in force.

During the angler's struggle with a fish, the situation occurs in which the fish, in order to escape the pull of the line, quickly swims towards the angler. This brings with it the risk that the line becomes slack, i.e., it looses its tension, and can result in the hook falling out of the fish's mouth and the fish being lost. The angler tries to prevent this by cranking in faster, i.e., by increasing the rate of revolutions of the reel spool. However, this increase in the rate of revolutions has its anatomical limits.

In order to be able to attain the required speed nonetheless, reels have been equipped with a gearing that gears the rate of revolutions of the crank handle to the spool by the factor of the gearing (U.S. Pat. No. 3,806,060 or U.S. Pat. No. 3,720,386).

This makes it possible to attain a sufficient reel-in speed. The shortcoming of this device is that the required peripheral force for turning the crank increases as well, by the factor of the gear multiplication. This is particularly disadvantageous if the intent is not only to tighten a loose line, but to reel in against the force of the fish. To eliminate this disadvantage, reels have been developed with various gearing levels. However, due to the increased weight, this design has gained acceptance only for the heaviest troll reels. With reels for fly fishing, importance is placed, besides other properties, especially on a low weight since the reel must be a balanced system together with the rod. Otherwise the special casting with fly fishing equipment is not possible. Reels of the above type also become more complex in their design.

It is for this reason that a different route has recently been pursued for reels used in fly fishing. To be able to attain the desired higher speed when reeling in the line, the outer diameter of the reel is increased. The intent is to increase the speed while keeping the number of crank revolutions the same. It is a shortcoming, however, that when the diameter is increased, the crank is also mounted on a larger diameter. As a result, the angler's hand must move along a larger circle, which can no longer be achieved with the wrist alone but with an additional movement of the lower arm. The rate of revolutions that is attainable in this manner is lower than by cranking only from the wrist. However, if the crank is mounted on a smaller diameter the uneven lever ratio—radius of the line to radius of the crank—results in an unacceptable increase in the force required during cranking against the fish.

It is the object of the invention to improve a reel with a large outer diameter in such a way that the shortcomings of known designs are prevented by the simplest possible means.

This object is met with the characterizing portions of claim 1.

This approach makes possible a fishing reel with a large diameter, particularly for fly fishing, wherein the desired high speed during reeling in of the line or the required low cranking force during reeling in of the line is attained by the simplest possible means. This advantageous approach may be applied both for a reel of the “direct drive” type, i.e., a reel wherein the hand crank is mounted directly on the spool, as well as for an “anti-reverse” type reel wherein the driving torque is transferred by means of a crank via a sliding clutch to the spool.

In a direct-drive reel the approach lies in two de facto identical handles that are fixed on the spool with different radii to the center of the reel but preferably opposite one another by 180°. In an anti-reverse reel the approach lies in two de facto identical handles that are fixed on the driving crank with different radii to the center of the reel but preferably opposite one another by 180° C.

The handle with the smaller radius, which is preferably positioned close to the reel axis, can be rotated along a small circle, i.e., only from the wrist and thus with a relatively higher number of revolutions. The forces on the line that are attainable in this manner are reduced by the lever ratio—small radius of the handle to radius of the line on the spool. However, since this small radius handle is intended only to maintain the tension of the line when a fish is swimming towards the angler, no great force is required but only high speed.

When the fish again pulls forcefully, the angler switches to the handle with the larger radius, which is preferably located close to the radius of the line. As a result, he can crank with a lower required force. A high speed is not required at this time.

The inventive approach is particularly advantageous in reels of the “anti-reverse” type as the crank will definitely stand still when switching between the handles during this drill. A preferred embodiment of the inventive approach is explained in the appended drawing.

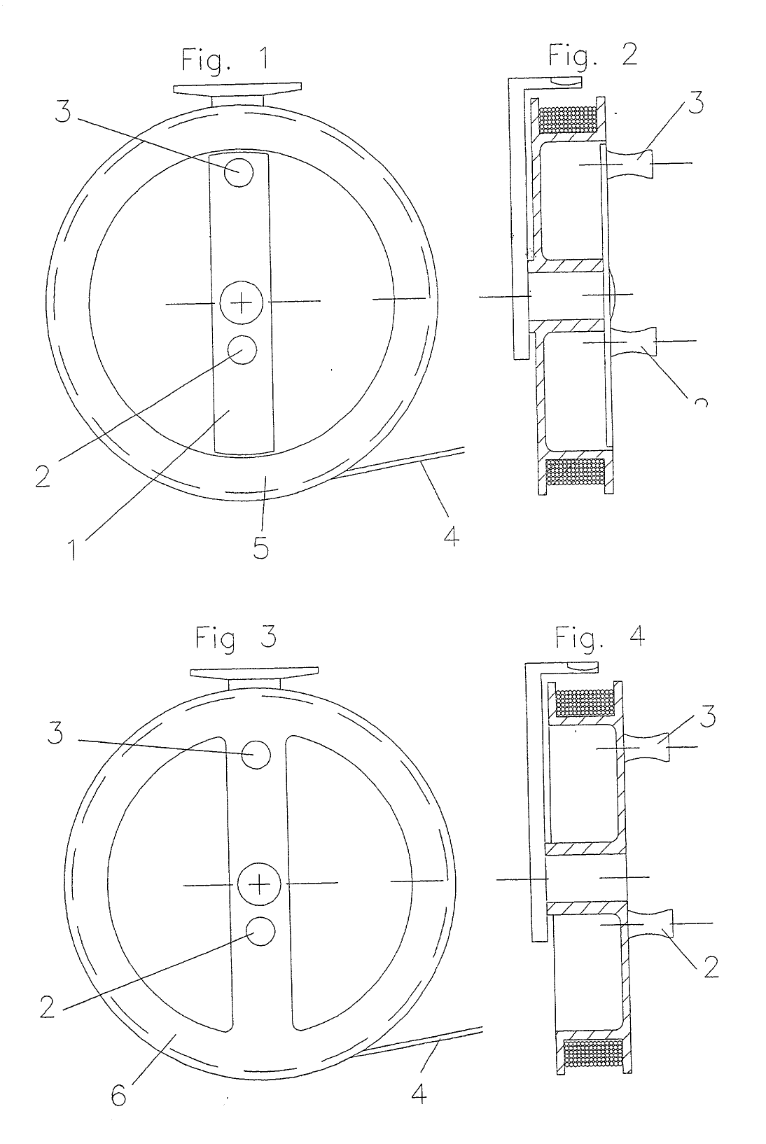

FIG. 1 shows a fishing reel of the “anti-reverse” type with the crank 1, the handle 2 with a small radius fixed thereupon, the handle 3 with a large radius, and the line 4 on the spool 5.

FIG. 2 shows a section through the reel of FIG. 1

FIG. 3 shows a fishing reel of the “direct-drive” type with the spool 6, the handle 2 with a small radius fixed thereupon, the handle 3 with a large radius, and the line 4.

FIG. 4 shows a section through the reel of FIG. 3.

What is claimed is:

1. A fishing reel without a gear with a large diameter, especially for fly fishing, characterized
in that the crank (1) or the spool (6) has an assigned handle (2) with a short distance to the reel center and a second handle (3) with a large distance to the reel center.

2. A fishing reel according to claim 1, characterized in that the two handles are preferably positioned in an angle of 180 degrees towards one another.
